(19) United States
(12) Patent Application Publication
(10) Pub. No.: US 2026/0034645 A1
(43) Pub. Date: Feb. 5, 2026

(54) Ratchet Control for a Tool

(71) Applicant: Snap-on Incorporated, Kenosha, WI (US)

(72) Inventors: Daniel M. Eggert, Kenosha, WI (US); Jeffrey M. Arendt, Union Grove, WI (US)

(21) Appl. No.: 18/964,375

(22) Filed: Nov. 30, 2024

Related U.S. Application Data
(60) Provisional application No. 63/677,957, filed on Jul. 31, 2024.

(51) Int. Cl. B25B 13/46

(52) U.S. Cl. CPC B25B 13/463; B25B 13/468

(57) ABSTRACT

The present disclosure relates to a tool that includes a head having a cavity, and a ratchet assembly carried within the cavity and rotatable about a centerline. The ratchet assembly including a gear portion and a drive portion aligned along the centerline, and a pawl carrier rotatable within the cavity relative to the gear portion, and wherein the pawl carrier is rotatable between a first position and a second position, wherein the first position corresponds to a first pawl mechanically positioned along a groove to engage the gear portion and the second position corresponds to a second pawl mechanically positioned along the groove to engage the gear portion. The tool further includes a ratchet control including a ratchet lever configured to engaged a back surface of the head and a and a ratchet base disposed within the cavity, wherein the ratchet lever mechanically engages the ratchet base.

### CROSS-REFERENCE TO RELATED APPLICATION

This application claims priority to U.S. Provisional Application No. 63/677,957 filed on Jul. 31, 2024, the entire contents of which is hereby incorporated by reference.

### BACKGROUND

Handheld tools such as a ratchet may be used to engage an array of fasteners encountered in, for example, manufacturing and assembly applications across different industries. In one manufacturing and assembly application, the ratchet may include a drive portion to mechanically engage with and transfer torque to a fastening device, such as a nut. In operation, the transfer and application of torque allows for the tightening or loosening of the fastening device such as the nut. The ratchet, in one configuration, may incorporate one or more pawls supported by a pawl carrier. In operation, the pawl carrier engages with the drive portion restrict rotation of the drive portion in either a clockwise direction or a counterclockwise direction. For example, the pawls may mechanically cooperate with the pawl carrier to restrict the direction of rotation of the drive portion in the clockwise direction while allowing rotation in the counterclockwise direction. In other words, rotation is restricted to one direction at a time.

### SUMMARY

The present disclosure relates to hand tools, such as a ratchet, and a ratchet control for controlling the mechanical operation of the tools.

In one example embodiment, a tool includes a head having a cavity, and a ratchet assembly carried within the cavity and rotatable about a centerline. The ratchet assembly including a gear portion and a drive portion aligned along the centerline such that the drive portion extends away from the cavity. The tool further includes a pawl carrier rotatable within the cavity relative to the gear portion; wherein the pawl carrier cooperates with a first pawl having first teeth and a second pawl having second teeth, wherein the first pawl and the second pawl selectively engage with the gear portion as each moves along a groove provided in the pawl carrier, and wherein the pawl carrier is rotatable between a first position and a second position, wherein the first position corresponds to the first pawl mechanically positioned along the groove to engage the gear portion and the second position corresponds to the second pawl mechanically positioned along the groove to engage the gear portion. The tool further includes a ratchet control including a ratchet lever configured to engage a back surface of the head and a ratchet base disposed within the cavity, wherein the ratchet lever mechanically engages the ratchet base, and wherein the ratchet control is coupled to the pawl carrier to cause rotation between the first position and the second position.

In another example embodiment, a ratchet includes a handle and a ratchet head, wherein the ratchet head includes a cavity having a back wall and a ratchet assembly carried within the cavity. The ratchet further includes a ratchet lever configured to engage the back wall of the ratchet head, and a ratchet base disposed within the cavity, wherein the ratchet lever mechanically engages the ratchet base, and wherein the ratchet base is coupled to the ratchet assembly to cause rotation between a first position and a second position.

In another example embodiment, a method for securing a rachet lever includes positioning a ratchet lever adjacent to a back wall of a ratchet head, wherein the backwall is formed as part of a cavity sized to accept a ratchet assembly carried within the cavity. The method further includes extending a portion of the ratchet lever through the backwall, wherein the portion extends into the cavity. The method further includes securing a ratchet base to the portion of the ratchet lever through the backwall, wherein the ratchet base is disposed within the cavity. The securing includes mechanically engaging the ratchet base to the portion of the ratchet lever, and translating the ratchet lever such that the attached ratchet base coupled to the ratchet assembly causes rotation to switch between a first position and a second position.

Other embodiments will become apparent to those of ordinary skill in the art by reading the following detailed description, with reference where appropriate to the accompanying drawings.

### BRIEF DESCRIPTION OF THE DRAWINGS

Example embodiments are described herein with reference to the drawings.

FIG. 1 illustrates a ratchet, according to an example embodiment.

FIG. 2 illustrates an exploded perspective view of the ratchet, according to an example embodiment.

FIG. 3 illustrates an exploded perspective of a head of a ratchet, according to an example embodiment.

FIG. 4 illustrates another exploded perspective of a head of a ratchet, according to an example embodiment.

FIG. 5 illustrates an exploded perspective of a back wall of the head including a ratchet control, according to an example embodiment.

FIG. 6 illustrates a cross-sectional view of the head carrying the ratchet control, according to an example embodiment.

FIG. 7 illustrates an aligned assembly view of the ratchet control, according to an example embodiment.

FIG. 8 illustrates an assembly view of the ratchet control, according to an example embodiment.

FIG. 9 illustrates an assembly view of another ratchet control, according to an example embodiment.

The drawings are schematic and not necessarily to scale. In the drawings, similar symbols typically identify similar components, unless context dictates otherwise.

### DETAILED DESCRIPTION

The present disclosure relates to a ratchet control for a tool. The ratchet control is configured to be secured to a housing encompassing the ratchet assembly such that actuation or toggling of the ratchet assembly via the ratchet control maintains the mechanical engagement.

In one example embodiment, the ratchet control includes a ratchet lever configured to engage a back surface of the head and a ratchet base disposed within the cavity, wherein the ratchet lever mechanically engages the ratchet base, and wherein the ratchet control is coupled to the pawl carrier to cause rotation between the first position and the second position. The ratchet control operates to seal the back surface between the two components to prevent foreign body intrusion into the cavity. Because the ratchet control including the ratchet lever and the ratchet base are mechanically engaged, the ratchet control resists mechanical deflection when a large force is applied to the ratchet lever.

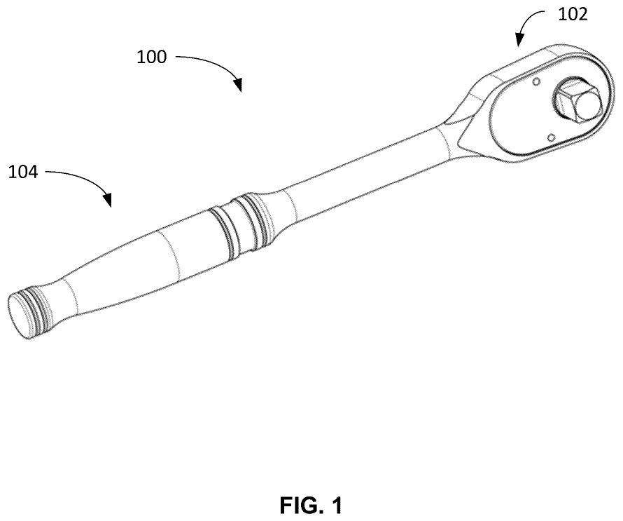

FIG. 1 illustrates a hand tool such as a ratchet 100, according to an example embodiment. The ratchet 100 may have a head 102 and a handle 104. The handle 104 may be attachable/detachable or integrated with the head 102.

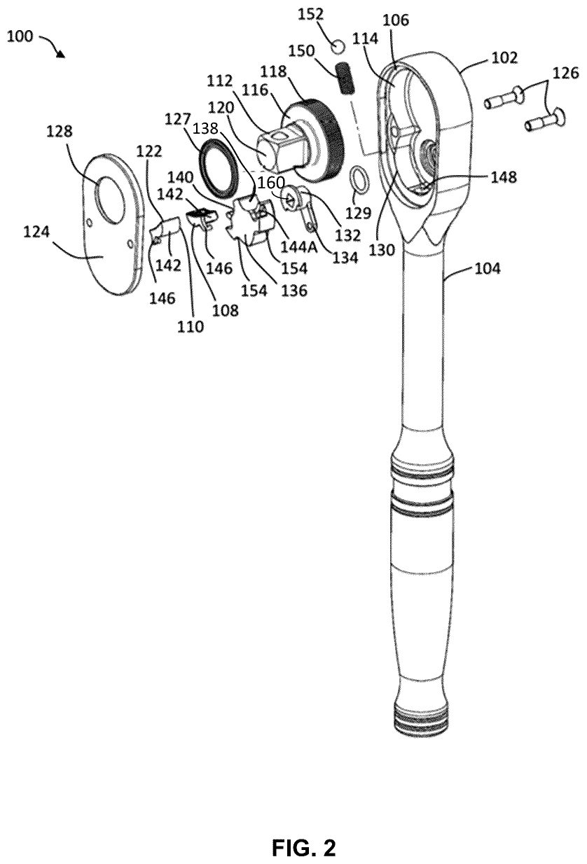

FIG. 2 illustrates an exploded perspective view of the ratchet 100 shown in FIG. 1, according to an example embodiment. As shown in the exploded view, the head 102 includes a cavity 106. The cavity 106 is sized and configured to receive the one or more components of the ratchet 100. In operation, the ratchet 100 allows the user to provide torque to a work piece (not shown) such as a socket and/or a fastener.

The cavity 106 includes portions for respectively receiving and retaining the one or more components of the ratchet 100. The ratchet head 112 is received in a first portion of the cavity 106, referred to herein as a drive cavity 114. In some examples, the drive cavity 114 is large and generally circular. The ratchet head 112 has a generally circular body portion 116 with a circumferential toothed portion 118, and a drive portion 120, such as, for example, a square drive lug, projecting away from the body portion 116 and the head 102. The toothed portion 118 may be formed as part of the circular body portion 116 or may be a gear fixedly attached to the circular body portion 116.

The head 102 includes first and second pawls 108, 110 disposed in the cavity 106. The first pawl 108 and the second pawl 110 are selectively engageable with the ratchet head 112 that is operatively engageable with the work piece. For example, the toothed portion 118 of the ratchet head 112 selectively engages pawl teeth 122 formed on one of the pawls 108, 110 in order to individually engage one of the pawls 108, 110 to provide torque drive through the drive portion 120 in either of the first and second rotational drive directions. In operation, when the pawl teeth 122 of the first pawl 108 engages the toothed portion 118 of the ratchet head 112, torque drive is permitted with rotation of the head 102 in a first rotational direction while ratcheting occurs with rotation of the head 102 in a second rotational drive direction opposite the first rotational drive direction. When the pawl teeth 122 of the second pawl 110 engages with the toothed portion 118 of the ratchet head 112, the first pawl 108 disengages the ratchet head 112, and torque drive is permitted with rotation of the head 102 in the second rotational drive direction while ratcheting occurs with rotation of the head 102 in the first rotational drive direction.

A cover plate 124 is secured to the head 102 to enclose the components of the ratchet 100 in the cavity 106. In some examples, the cover plate 124 is retained to the head 102 using fasteners 126, such as, for example, screws or rivets. The cover plate 124 includes an opening 128, such as, for example, a circular bore, through which the drive portion 120 projects for operative engagement with the work piece. The opening 128 also defines a bearing surface for the drive portion 120 to retain and position the ratchet head 112. A cover plate seal 127 may mate between surfaces of the cover plate 124 and the ratchet head 112 to reduce ingress of foreign material (e.g., dirt, debris, and/or fluids) through the opening 128.

The first pawl 108 and the second pawl 110 are disposed in a second portion of the cavity 106, referred to herein as the pawl cavity 130. The drive cavity 114 and pawl cavity 130 overlap or communicate to allow the first and second pawls 108, 110 to selectively move into and out of engagement with the toothed portion 118 of the ratchet head 112.

A ratchet control 132 is configured to selectively cause the engagement and disengagement of the first and second pawls 108, 110 with the ratchet head 112 is provided. In some examples, the ratchet control 132 is disposed in the pawl cavity 130. The ratchet control 132 extends through the head 102 where a ratchet lever or lever arm 134 of the ratchet control 132 is positioned on the outside of the head 102 and is adapted to be manually operated by a user to select a drive direction of the ratchet 100. A seal 129 is circumferentially disposed around the lever arm 134 to reduce, impede, or prevent contaminants or liquid from entering the cavity 106. In some examples, the ratchet control 132 is assembled with the head 102 by inserting the lever arm 134 into the pawl cavity 130 from a first side of the head 102, and by extending the lever arm 134 through an opening in the head 102 to a second side of the head 102, which promotes the ability to utilize the seal 129 for preventing ingress of contaminants.

In some examples, the ratchet control 132 is fixedly coupled to a pawl carrier 136 such that the position of the pawl carrier 136 is based on the position of the lever arm 134 portion of the ratchet control 132. In other words, the movement of the lever arm 134 causes the pawl carrier 136 to selectively position one of the pawls 108, 110 into engagement with the toothed portion 118 of the ratchet head 112 in order to select the torque drive direction.

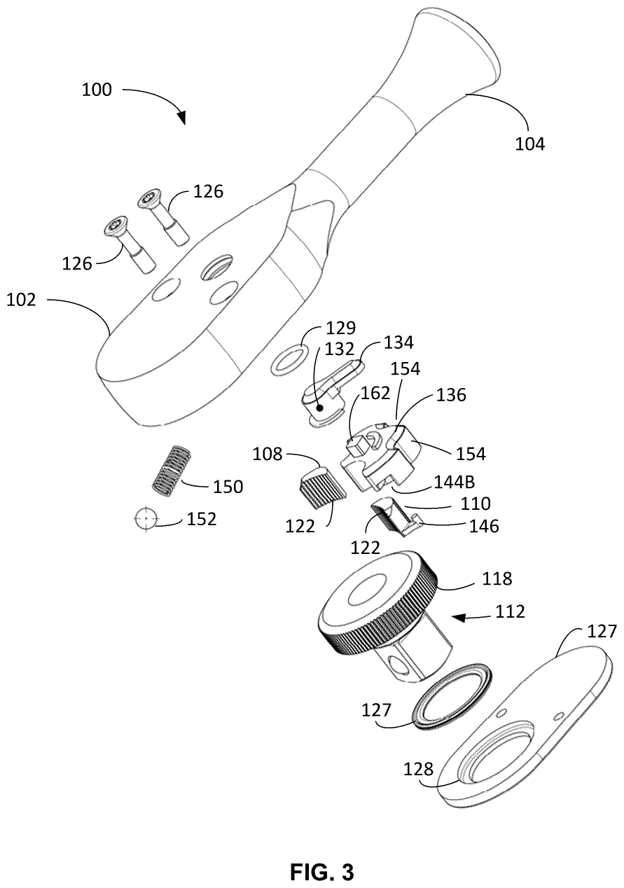

FIG. 3 illustrates an exploded perspective of the head 102 of the ratchet 100, according to an example embodiment. In the example illustrated in FIG. 3, the ratchet control 132 includes a mounting pocket 160 posited to fixedly engage a square post 162. As shown in FIG. 2 and FIG. 3, the pawl carrier 136 includes first and second recesses 138, 140. Each of the pawls 108, 110 includes a surface 142 opposite the pawl teeth that is correspondingly shaped to substantially correspond to the first and second recesses 138, 140. In some examples, the surface 142 is circular or arcuately shaped, and the first and second recesses 138, 140 have a concavity or convexity substantially similar to that of the circular or arcuately shaped surface 142 of each of the pawls 108, 110. The pawl carrier 136 includes a pair of detents 154. The detents 154 may selectively engage a ball 152, retained by a biasing member 150 within a bore 148 of the ratchet 100, when the ratchet control 132 is disposed in the proper position for selection of the first and second torque drive directions.

The differing perspective view of FIG. 2 and FIG. 3, illustrates that the pawl carrier 136 also includes a groove, for example first and second grooves 144A, 144B, disposed adjacent the first and second recesses 138, 140. In some examples, the grooves 144A, 144B are formed along an arcuately shaped path to substantially correspond to the concavity or convexity shape of the first and second recesses 138, 140. The first and second pawls 108, 110 each includes a projection 146 adapted to respectively slidably engage the grooves 144A, 144B. For example, the projection 146 of the first pawl 108 engages the first groove 144A, and the projection 146 of the second pawl 110 engages the second groove 144B. Although two separate grooves 144A, 144B are illustrated, in other examples a single groove adapted to selectively engage the projection 146 of the respective first and second pawls 108, 110 may be used. In some examples, an end portion of the projection 146 may have an arcuate (e.g., rounded) profile, while in other examples the end portion of the projection 146 may be planar.

In operation, as the pawl carrier 136 is shifted by the ratchet control 132 when the lever arm 134 is moved to a first position to select a first rotational drive direction, the first groove 144A engages the projection 146 of the first pawl 108 to push the first pawl 108 into engagement with the ratchet head 112. Simultaneously, as illustrated in Figured 3, the second groove 144B engages the projection 146 of the second pawl 110 to cause the second pawl 110 to disengage from the ratchet head 112. Accordingly, the pawl teeth 122 of the first pawl 108 remain in engagement with the toothed portion 118 of the ratchet head 112 when the head 102 is moved in the first rotational drive direction. As the pawl carrier 136 is shifted by the ratchet control 132 when the lever arm 134 is moved to a second position to select a second rotational drive direction, the second groove 144B engages the projection 146 of the second pawl 110 to push the second pawl 110 into engagement with the ratchet head 112. Simultaneously, the first groove 144A engages the projection 146 of the first pawl 108 to cause the first pawl 108 to disengage from the ratchet head 112. Accordingly, the pawl teeth 122 of the second pawl 110 engages the toothed portion 118 of the ratchet head 112 when the head 102 is moved in the second rotational drive direction.

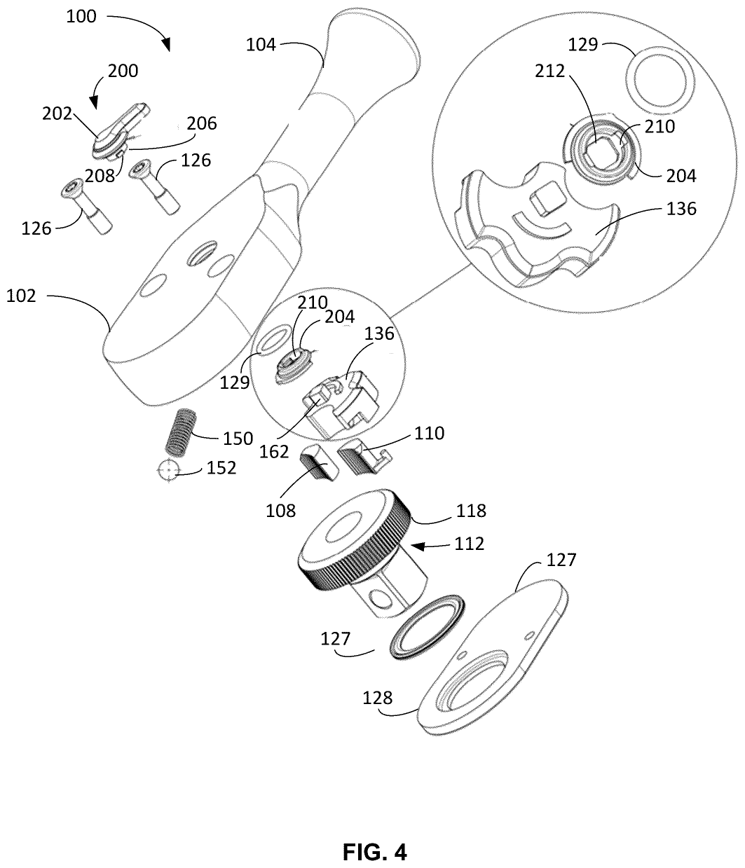

FIG. 4 illustrates another exploded perspective of the head 102 of the ratchet 100, according to an example embodiment. In this example embodiment, a ratchet control is a ratchet assembly 200 including a lever cap 202 and a lever base 204. In this example embodiment, the lever cap 202 engages the lever base 204 via a through-hole 206 provided in a back surface 208 of the head 102. The ratchet assembly 200 may be operated to selectively cause the engagement and disengagement of the first and second pawls 108, 110 with the ratchet head 112.

The lever cap 202 may include a cylindrical base 206 including one or more tabs 208. The lever cap 202 when engaged with the back surface 208 includes the cylindrical base 206 and the one or more tabs 208 rotatable within the through-hole 206. The lever cap 202 may further engage the lever base 204 contained within the cavity 106. The seal 129 may be circumferentially disposed around the lever base 204 and adjacent to an inner surface of the cavity 106 to reduce, impede, or prevent contaminants or liquid from entering the cavity 106. The lever base 204 includes a groove 210 sized to accept the one or more tabs 208. For example, the tabs 208 may be aligned with and fit into slots formed by the groove 210 such that once the two elements engage, the lever cap 202 may be rotated related to the lever base 204. In this manner, the tabs 208 may be positioned within the groove 210. The mechanical engagement between the tabs 208 and the groove 210 operate to secure the ratchet assembly 200 to the head 102.

As shown in the Detail of FIG. 4, the lever base 204 includes a square 212 sized to accept the square post 162. Similarly, the lever base 204 includes a complimentary square sized to accept the square post 162 and configured to align with the square 212 when the tabs 208 and the groove 210 are mechanically engaged. In this way, ratchet assembly 200 may be secured and mounted to the head 102 such that repeated actuation of the lever arm 202 maintains a mechanical connection.

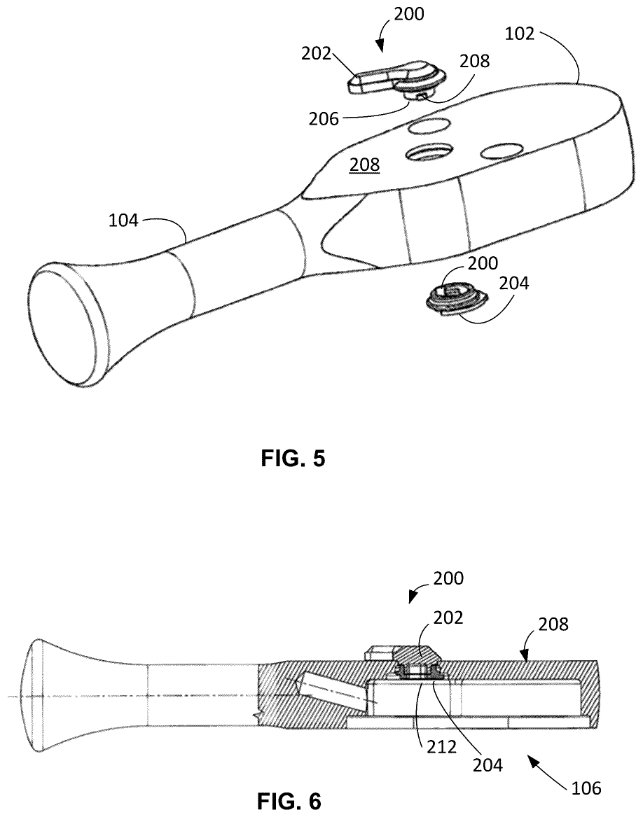

FIG. 5 illustrates an exploded perspective of the back wall 208 of the head 102 including the ratchet control 200 before assembly according to an example embodiment. The ratchet control 200 including the lever arm 202 and the tabs 208 may be aligned with and fit into slots formed by the groove 210 provided in the lever base 204.

FIG. 6 illustrates a cross-sectional view of the head 102 carrying the ratchet control 200. For example, the lever arm 202 and the tabs 208 engage with the groove 210 such that the square post 162 may be engaged with, and contained by, the square 212 formed when the ratchet control 200 is assembled.

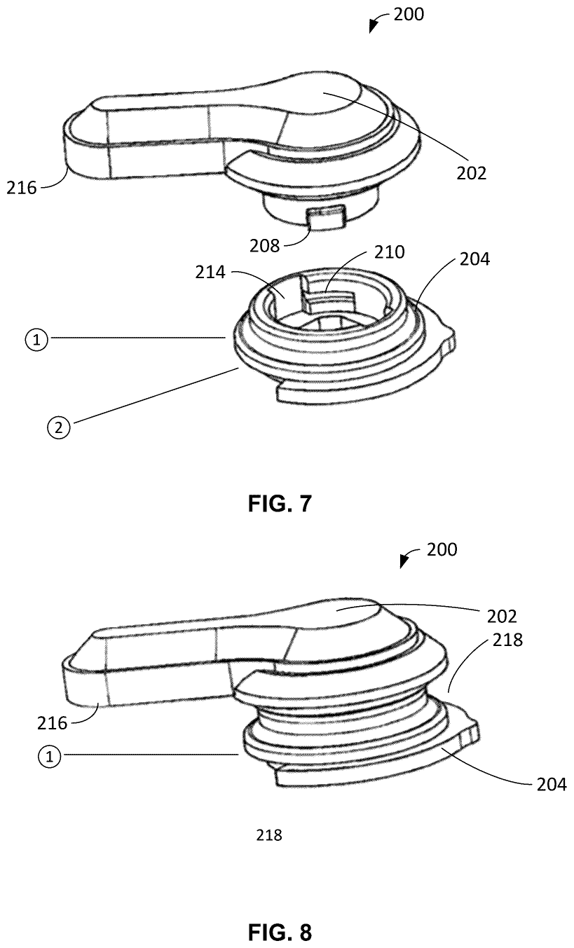

FIG. 7 illustrates an aligned assembly view of the ratchet control 200, according to an example embodiment. In this illustrated example, the ratchet control 200 including the lever arm 202 and the tabs 208 may be aligned with and fit into slots 214 formed by the groove 210 provided in the lever base 204. For example, the lever arm 202 may include a cylindrical portion sized to be accepted within a mating cylindrical portion of the lever base 204. In this example, the tabs 208 may be formed on an outer surface of the cylindrical portion and arranged to engage the groove 210 formed on an inner surface of the cylindrical portion of the lever base 204. For example, the toggle 216 of the lever arm 202 may be aligned as indicated by the leader line 2 when the tabs 208 engage the slot 214. Upon engagement, the tabs 208 may be rotated within the groove 210 as the toggle 216 rotates from the position indicated by the leader line 2 to the position indicated by the leader line 1.

FIG. 8 illustrates an assembly view of the ratchet control 200 when the lever arm 202 is engaged with the lever base 208 such that the square 212 are aligned to accept the square post 162. The cooperation of the lever arm 202 and the lever base 208 provide a gap 218 sized to accept the back wall 208 and the seal 129 compressively secured therebetween.

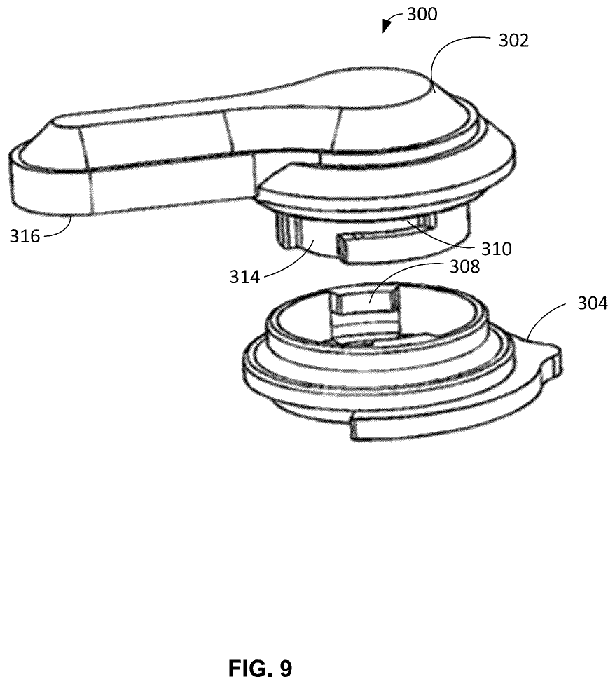

FIG. 9 illustrates an assembly view of another ratchet control 300, according to an example embodiment. In this illustrated example, the ratchet control 300 including the lever arm 302 formed with a groove 310 including one or more slots 314 sized to accept one or more tabs 308 formed into the lever base 304. For example, the toggle 316 of the lever arm 302 may be when the tabs 308 engage the slot 314. Upon engagement, the tabs 308 may be rotated within the groove 310 as the toggle 316 is rotated. It will be understood the locking mechanism described as part of the ratchet control 200 and ratchet control 300 may configured such that the tabs 208, 308 and groove 210, 310 may include the same profile and layout for manufacturing.

While various aspects and embodiments are described herein, other aspects and embodiments will be apparent to those skilled in the art. The various aspects and embodiments disclosed herein are for purposes of illustration and are not intended to be limiting, with the true scope being indicated by the claims, along with the full scope of equivalents to which such claims are entitled. It is also to be understood that the terminology used herein for the purpose of describing embodiments only, and is not intended to be limiting.

In this description, the articles “a,” “an,” and “the” are used to introduce elements and/or functions of the example embodiments. The intent of using those articles is that there is one or more of the introduced elements and/or functions.

In this description, the intent of using the term “and/or” within a list of at least two elements or functions and the intent of using the terms “at least one of,” “at least one of the following,” “one or more of,” “one or more from among,” and “one or more of the following” immediately preceding a list of at least two components or functions is to cover each embodiment including a listed component or function independently and each embodiment including a combination of the listed components or functions.

The use of ordinal numbers such as “first,” “second,” “third” and so on is to distinguish respective elements rather than to denote an order of those elements unless the context of using those terms explicitly indicates otherwise. Further, the description of a “first” element, such as a first arm and first portion, does not necessitate the presence of a second or any other element, such as a second arm and second portion.

Implementations of the present disclosure can thus relate to one of the enumerated examples (EE) listed below.
EE 1 is a tool comprising: a head having a cavity; a ratchet assembly carried within the cavity and rotatable about a centerline, the ratchet assembly including a gear portion and a drive portion aligned along the centerline such that the drive portion extends away from the cavity; a pawl carrier rotatable within the cavity relative to the gear portion; wherein the pawl carrier cooperates with: a first pawl having first teeth and a second pawl having second teeth, wherein the first pawl and the second pawl selectively engage with the gear portion as each moves along a groove provided in the pawl carrier, and wherein the pawl carrier is rotatable between a first position and a second position, wherein the first position corresponds to the first pawl mechanically positioned along the groove to engage the gear portion and the second position corresponds to the second pawl mechanically positioned along the groove to engage the gear portion; and a ratchet control including a ratchet lever configured to engaged a back surface of the head and a and a ratchet base disposed within the cavity, wherein the ratchet lever mechanically engages the ratchet base, and wherein the ratchet control is coupled to the pawl carrier to cause rotation between the first position and the second position.
EE 2 is the tool of EE 1, wherein the back surface is mechanically engage between the ratchet lever and the ratchet base.
EE 3 is the tool of EE 1 or EE 2, wherein the ratchet control extends between a through-hole provided in the back surface.
EE 4 is the tool of EE 3, wherein the ratchet lever includes a cylindrical sleeve arranged to extend between the through-hole.
EE 5 is the tool of EE 4, wherein the ratchet base engages the cylindrical sleeve to secure the ratchet lever adjacent to the back surface.
EE 6 is the tool of EE 4 or EE 5, wherein the cylindrical sleeve includes a follower arranged to engage a cam provided in the ratchet base.
EE 7 is the tool of EE 4 or EE 5, wherein the cylindrical sleeve includes a cam arranged to engage a follower provided in the ratchet base.
EE 8 is the tool of any of EE 4 to EE 7, wherein the ratchet base includes a cylindrical wall having a cam provided as part of the cylindrical wall.
EE 9 is a ratchet including a handle and a ratchet head, wherein the ratchet head includes a cavity having a back wall and a ratchet assembly carried within the cavity, wherein the ratchet comprises: a ratchet lever configured to engage the back wall of the ratchet head; and a ratchet base disposed within the cavity, wherein the ratchet lever mechanically engages the ratchet base, and wherein the ratchet base is coupled to the ratchet assembly to cause rotation between a first position and a second position.
EE 10 is the ratchet of EE 9, wherein the ratchet assembly is rotatable about a centerline, the ratchet assembly including a gear portion and a drive portion aligned along the centerline.
EE 11 is the ratchet of EE 10, wherein the drive portion aligned along the centerline extends away from the cavity and the back wall.
EE 12 is the ratchet of EE 10 or EE 11, wherein the ratchet assembly includes a pawl carrier rotatable within the cavity relative to the gear portion.
EE 13 is the ratchet of EE 12, wherein the pawl carrier cooperates with a first pawl having first teeth and a second pawl having second teeth, wherein the first pawl and the second pawl selectively engage with the gear portion as each moves along a groove provided in the pawl carrier.
EE 14 is the ratchet of EE 13, wherein the pawl carrier is rotatable between the first position and the second position, wherein the first position corresponds to the first pawl mechanically positioned along the groove to engage the gear portion and the second position corresponds to the second pawl mechanically positioned along the groove to engage the gear portion.
EE 15 is the ratchet of any of EE 9 to EE 14, wherein the ratchet lever extends between a through-hole provided in the back wall.
EE 16 is the ratchet of EE 15, wherein the ratchet lever includes a cylindrical sleeve arranged to extend between the through-hole.
EE 17 is the ratchet of EE 16, wherein the ratchet base engages the cylindrical sleeve to secure the ratchet lever adjacent to the back wall.
EE 18 is the ratchet of EE 16 or EE 17, wherein the cylindrical sleeve includes a follower arranged to engage a cam provided in the ratchet base.
EE 19 is the ratchet of EE 16 or EE 17, wherein the cylindrical sleeve includes a cam arranged to engage a follower provided in the ratchet base.
EE 20 is a method for securing a rachet lever. The method includes positioning a ratchet lever adjacent to a back wall of a ratchet head, wherein the backwall is formed as part of a cavity sized to accept a ratchet assembly carried within the cavity; extending a portion of the ratchet lever through the backwall, wherein the portion extends into the cavity; and securing a ratchet base to the portion of the ratchet lever through the backwall, wherein the ratchet base is disposed within the cavity. The securing includes mechanically engaging the ratchet base to the portion of the ratchet lever; and translating the ratchet lever such that the attached ratchet base coupled to the ratchet assembly causes rotation to switch between a first position and a second position.

What is claimed is:

1. A tool comprising:
a head having a cavity;
a ratchet assembly carried within the cavity and rotatable about a centerline, the ratchet assembly including a gear portion and a drive portion aligned along the centerline such that the drive portion extends away from the cavity;
a pawl carrier rotatable within the cavity relative to the gear portion; wherein the pawl carrier cooperates with:
a first pawl having first teeth and a second pawl having second teeth, wherein the first pawl and the second pawl selectively engage with the gear portion as each moves along a groove provided in the pawl carrier, and
wherein the pawl carrier is rotatable between a first position and a second position, wherein the first position corresponds to the first pawl mechanically positioned along the groove to engage the gear portion and the second position corresponds to the second pawl mechanically positioned along the groove to engage the gear portion; and
a ratchet control including a ratchet lever configured to engage a back surface of the head and a ratchet base disposed within the cavity, wherein the ratchet lever mechanically engages the ratchet base, and wherein the ratchet control is coupled to the pawl carrier to cause rotation between the first position and the second position.

2. The tool of claim 1, wherein the back surface is mechanically engaged between the ratchet lever and the ratchet base.

3. The tool of claim 1, wherein the ratchet control extends between a through-hole provided in the back surface.

4. The tool of claim 3, wherein the ratchet lever includes a cylindrical sleeve arranged to extend between the through-hole.

5. The tool of claim 4, wherein the ratchet base engages the cylindrical sleeve to secure the ratchet lever adjacent to the back surface.

6. The tool of claim 5, wherein the cylindrical sleeve includes a follower arranged to engage a cam provided in the ratchet base.

7. The tool of claim 5, wherein the cylindrical sleeve includes a cam arranged to engage a follower provided in the ratchet base.

8. The tool of claim 4, wherein the ratchet base includes a cylindrical wall having a cam provided as part of the cylindrical wall.

9. A ratchet including a handle and a ratchet head, wherein the ratchet head includes a cavity having a back wall and a ratchet assembly carried within the cavity, wherein the ratchet comprises:
a ratchet lever configured to engage the back wall of the ratchet head; and
a ratchet base disposed within the cavity, wherein the ratchet lever mechanically engages the ratchet base, and wherein the ratchet base is coupled to the ratchet assembly to cause rotation between a first position and a second position.

10. The ratchet of claim 9, wherein the ratchet assembly is rotatable about a centerline, and wherein the ratchet assembly includes a gear portion and a drive portion aligned along the centerline.

11. The ratchet of claim 10, wherein the drive portion aligned along the centerline extends away from the cavity and the back wall.

12. The ratchet of claim 9, wherein the ratchet assembly includes a pawl carrier rotatable within the cavity relative to the gear portion.

13. The ratchet of claim 12, wherein the pawl carrier cooperates with a first pawl having first teeth and a second pawl having second teeth, and wherein the first pawl and the second pawl selectively engage with the gear portion as each moves along a groove provided in the pawl carrier.

14. The ratchet of claim 13, wherein the pawl carrier is rotatable between the first position and the second position, and wherein the first position corresponds to the first pawl mechanically positioned along the groove to engage the gear portion and the second position corresponds to the second pawl mechanically positioned along the groove to engage the gear portion.

15. The ratchet of claim 9, wherein the ratchet lever extends between a through-hole provided in the back wall.

16. The ratchet of claim 15, wherein the ratchet lever includes a cylindrical sleeve arranged to extend between the through-hole.

17. The ratchet of claim 16, wherein the ratchet base engages the cylindrical sleeve to secure the ratchet lever adjacent to the back wall.

18. The ratchet of claim 16, wherein the cylindrical sleeve includes a follower arranged to engage a cam provided in the ratchet base.

19. The ratchet of claim 16, wherein the cylindrical sleeve includes a cam arranged to engage a follower provided in the ratchet base.

20. A method for securing a rachet lever, the method comprising:
positioning a ratchet lever adjacent to a back wall of a ratchet head, wherein the backwall is formed as part of a cavity sized to accept a ratchet assembly carried within the cavity;
extending a portion of the ratchet lever through the backwall, wherein the portion extends into the cavity;
securing a ratchet base to the portion of the ratchet lever through the backwall, wherein the ratchet base is disposed within the cavity, wherein securing includes:
mechanically engaging the ratchet base to the portion of the ratchet lever; and
translating the ratchet lever such that the attached ratchet base coupled to the ratchet assembly causes rotation to switch between a first position and a second position.
